(19) United States
(12) Patent Application Publication
(10) Pub. No.: US 2026/0266147 A1
(43) Pub. Date: Sep. 10, 2026

(54) SYSTEM FOR COLLECTING DRILLING SLURRY

(71) Applicant: Hilti Aktiengesellschaft, Schaan (LI)

(72) Inventors: Philipp LORENZ, München (DE); Bernhard TRIENDL, Herrsching (DE); Goran GOLUBOVIC, Buchloe (DE); Gabor VIDA, Chur (CH); Bernhard KUNZ, Schaan (LI); Georg HOLZMEIER, Marktoffingen (DE); Eugen WEIT, Königsbrunn (DE); Mathias MÖNCH, Augsburg (DE); Franz HUBER, Markt Wald/ Oberneufnach (DE)

(21) Appl. No.: 18/873,615

(22) PCT Filed: Jun. 16, 2023
(86) PCT No.: PCT/EP2023/066195

§ 371 Date: Dec. 10, 2024

(30) Foreign Application Priority Data
Jul. 1, 2022 (EP) 22182443.6

(51) Int. Cl. E21B 21/015

(52) U.S. Cl. CPC E21B 21/015

(57) ABSTRACT

A system for collecting drilling slurry generated during operation of a core drilling machine is provided, wherein the system includes a collection device as a functional unit, wherein the collection device is attachable to a substrate by a vacuum, wherein the vacuum can be generated by a vacuum pump which is part of a drive unit of the system. The drive unit additionally-includes a power supply unit for supplying electrical power to the drive unit and its components.

The present invention relates to a system for collecting drilling slurry generated during operation of a core drilling machine. The drive unit additionally comprises a power supply unit for supplying electrical power to the drive unit and its components.

### BACKGROUND OF THE INVENTION

In the field of core drilling machines, various devices are known for collecting drilling slurry produced during the execution of a core drilling operation. For example, water trap rings are known that can be attached to the substrate using mechanical fastening means, such as clips or clamping means. Other devices are attached to a substrate by means of a vacuum created by a suction device.

### SUMMARY OF THE INVENTION

However, the mechanical fastening means are associated with the disadvantage that they often cannot be removed from the substrate non-destructively, and therefore minor damage to the substrate cannot be ruled out.

When attaching the water trap rings with a vacuum, the problem is that the water trap ring can only be attached to the substrate and held there when the suction device is switched on and in operation. However, continuous operation of the suction device is not required to perform the core drilling, and suction devices consume a particularly large amount of electrical power, especially when idle. This disadvantage weighs even more heavily when battery-powered suction devices are used, which have only a limited amount of on-board power due to their supply of electrical power from batteries or the like. However, even if mains-powered suction devices are used, it is obvious that attaching conventional water trap rings by means of a suction device leads to unnecessarily high energy consumption. In addition, continuous operation of the suction device can lead to increased noise pollution on a construction site.

Furthermore, if the water trap ring can only be attached to the substrate while a suction device is in operation, it is a further disadvantage that the drilling site or construction site cannot be prepared for the core drilling to be carried out. However, this would be desirable for an efficient flow of work on a construction site.

When using a suction device with automatic false air cleaning of a filter, there is a risk that the water trap ring will detach from the wall or substrate due to the possibly reduced suction power of the suction device during filter cleaning.

It is an object of the present invention to overcome the above-described defects and drawbacks of the prior art and of providing a system for collecting drilling slurry, with which the execution of core drilling operations can be assisted time- and energy-efficiently. In particular, when the system to be provided is used in conjunction with a battery-powered suction device to remove drilling slurry from the working area of a core drilling machine, the system is not intended to shorten the run time of the battery-powered suction device, but to contribute to increasing the range of a “battery charge”. In addition, the system should be easy and straightforward to attach to a substrate and should ensure good adhesion to various surfaces, including rough ones. Furthermore, a person skilled in the art would welcome it if the system to be provided could be used for many differently sized drill bits of a core drilling machine.

The present invention provides a system for collecting drilling slurry produced during operation of a core drilling machine is provided. The collection system comprises a collection device as a functional unit, wherein the collection device is attachable to a substrate by means of a vacuum, wherein the vacuum can be generated by a vacuum pump which is part of a drive unit of the system, wherein the drive unit additionally comprises a power supply unit for supplying the drive unit and its components with electrical power.

The invention can provide a collection system that can be attached to a substrate independently of the core drilling machine and/or an external suction device. Application tests have shown that the system can be attached to a substrate particularly easily and quickly at a site of operation, so that rapid readiness for use can be ensured. In particular, the system can be attached to the substrate before the actual start of the core drilling, since the vacuum used to attach the system is generated by the system itself or its vacuum pump. In this respect, the attachment of the collection system is independent of the use or operation of a suction device used to draw up the drilling slurry. In addition, the invention can reduce noise emissions at a construction site, and can also reduce energy consumption.

The system comprises a drive unit and a functional unit, wherein the functional unit has a collection device which can be arranged around a drill bit of a core drilling machine or a drilling site. Drilling slurry collects in an interior space of the collection device when core drilling is being carried out, wherein this drilling slurry can be extracted from the interior space of the collection device by means of a suction device. For this purpose, the collection device can have an extraction opening which opens towards the interior space of the collection device and can be connected to the suction device via a suction hose. The functional unit comprises a vacuum pump and a power supply device, wherein the power supply device is set up to supply the vacuum pump with electrical power.

In the context of the invention, it is preferred that the drive device is able to be fastened to the functional unit detachably. In other words, the drive unit and the functional unit represent two separately formed units, wherein the collection system can thus be of modular design. In the context of the invention, the term “modular” preferably means that the collection system comprises a drive unit with power supply device and vacuum pump and a functional unit with collection device and optionally a vacuum plate, wherein the functional unit and the drive unit are designed to be detachable from each other and can be used individually. For example, the functional unit can be used at a different construction site with a different drive unit. Alternatively, it is possible for the same drive unit to be used on the same construction site with a different functional unit if, for example, a smaller or a larger borehole is to be created, preferably with drill bits of different sizes. By separating the drive unit and the functional unit, the user can use the separate units in a particularly flexible way, and the system can be used to cover a wide range of drill bits of different sizes.

In one embodiment of the invention, the functional unit comprises a vacuum plate for transferring the vacuum to the substrate. In an operating state of the collection system, the functional unit and the drive unit are present attached to each other so that a vacuum can be generated by the vacuum pump of the drive unit and can be transferred, by means of the vacuum plate, to the substrate on which the collection system is to be mounted. The formulation that the vacuum is transferred to the substrate by means of the vacuum plate preferably means, in the context of the present invention, that the vacuum plate has voids and/or cavities on an underside, wherein the voids and/or cavities can be evacuated, i.e. pumped out, by means of the vacuum pump. When the vacuum plate, preferably with its underside, rests on the substrate to which the collection system is to be attached, the substrate closes off the previously open voids and/or cavities so that an evacuable space is created. This can be evacuated by means of the vacuum pump so that there is a lower pressure in the voids and/or cavities of the vacuum plate than in the environment of the collection system. This lower pressure, which is also preferably referred to as negative pressure or vacuum in the context of the invention, allows the collection system to be attached to a substrate. It is preferred in the context of the invention that the collection system is pressed against the substrate by the pressure difference between the pressure in the environment of the system and the pressure in the vacuum chamber, and is thereby securely fastened.

The collection system can also be used together with a core drilling machine. Core drilling machines are designed to cut substantially cylindrical drill cores from a substrate. The substrate may be, for example, stone, masonry or concrete, without being limited thereto. After a drill core has been cut out, a hollow-cylinder-like hole remains in the substrate to be worked, in which, for example, cable shafts, pipes or lines can be laid. In the context of the invention, the location where the borehole is to be introduced into the substrate is referred to as the “drilling location” or “drilling site”. For cutting out the substantially cylindrical drill cores, the core drilling machine can comprise a drill bit which can be attached to the core drilling machine by a tool holder. On its front side, the drill bit can include cutting segments that can be studded with, for example, artificial diamonds or diamond chips to increase the cutting power of the drill bit. In such cases, the term “diamond drill bit” is often used. The core drilling machine can be a hand-held core drilling machine that is held by a user and driven into the substrate. However, it may also be preferred in the context of the invention that the core drilling machine be attached to a drill rig during its operation, such that the drill rig holds the core drilling machine. In such a case, the propulsion can be generated by a so-called feed device. Feed devices can, for example, be formed by an automatic add-on module which can be connected to the core drilling machine and/or the drill rig. However, the feed device can also be formed as a handwheel, which is used to drive the core drilling machine into the substrate. Furthermore, the system can be used together with a hammer drill. The functional unit can for example comprise a dust collection device or can be formed by one.

In a very particularly preferred embodiment, the collection system can be operated together with a core drilling machine and, if necessary, connected thereto. It is preferred in the context of the invention that the collection device of the collection system is designed as a collection ring, wherein the collection ring can be placed around the drill bit of the core drilling machine or around the drilling site. The collection ring preferably has an inner side which faces the drill bit of the core drilling machine when the collection system and the core drilling machine interact. There can be provided on this inner side of the collection ring an extraction opening, through which drilling slurry or the like can be extracted from the interior space of the collection ring. The drilling slurry is produced, for example, during operation of the core drilling machine when drilling dust or particles, released whilst the drill core is being cut away, mix with water. Water is used in core drilling to cool the drill bit on the one hand, and on the other hand to bind the drilling dust produced during drilling and prevent it from entering the respiratory tract of the user of the core drilling machine. If a drilling slurry collection system is not used during core drilling, the drilling slurry can spread or disperse unhindered around the drilling site or on the construction site, resulting in large-scale contaminations and water damage. By means of the collection system, the drilling slurry can be extracted at the point of origin, preferably in the interior space of the collection ring, and thus removed directly. This prevents large-scale contamination and possible water damage from the outset and considerably reduces the cleaning and disposal effort after completion of the core drilling work.

After the core drilling work has been completed, the collection system can be disassembled and transported away from the site. For this purpose, the drive unit and the functional unit of the system can be disassembled and stored and/or transported individually. Core drilling operations are often carried out with drill bits of different diameters, depending on how large the desired borehole is to be. Therefore, it is convenient if the collection system comprises collection rings of different sizes and different diameters. In this way, optimum extraction of drilling slurry can be ensured, wherein the size of the collection ring is advantageously matched to the diameter of the drill bit. In other words, the size of the collection ring can correspond to the diameter of the collection ring. The collection system can thus advantageously be offered as a kit comprising differently sized collection rings. The possibility of offering the collection system as a kit is made possible by the separation of the drive unit and the functional unit of the system. By making the drive unit and the functional unit detachable from each other, the drive unit can be used with different collection rings and/or vacuum plates. In particular, it is only necessary for a service provider performing core drilling work to purchase a cost-intensive drive unit, which can then be used together with different collection rings and/or vacuum plates, wherein the collection rings and/or vacuum plate are mostly cheaper to purchase.

The collection ring and the vacuum plate can be designed to be detachably connectable. However, the collection ring and the vacuum plate can also form a unit with each other. For example, the first end of the suction hose can open out into the vacuum plate, wherein an opening is provided in the vacuum plate that leads to the extraction opening of the collection ring. The extracted drilling slurry is then sucked from the extraction opening through this line and through the suction hose in the direction of the suction device.

The drilling slurry is preferably extracted by means of a suction device which can be connected to the collection system, in particular the functional unit or the collection ring, via a suction hose. A first end of the suction hose opens out into the extraction opening of the collection ring, for example, while the second end of the suction hose is connected to the suction device. The suction device can comprise a receiving container for receiving the drilling slurry. It may be preferred in the context of the invention that the drilling slurry is filtered and the water filtered out is reused.

In the context of the invention, it is preferred that the functional unit comprises a vacuum plate for transferring the vacuum to the substrate. Preferably, the vacuum plate has a lower side and an upper side. On its underside, the vacuum plate can have the voids and/or cavities which can form vacuum chambers in the context of the invention. A vacuum can be generated in the vacuum chambers of the vacuum plate by means of the vacuum pump of the drive unit, wherein the vacuum is preferably lower than an ambient or atmospheric pressure surrounding the collection system. As a result, the collection system can be attached to a substrate, wherein the substrate can be worked with a core drilling machine, for example by drilling holes into the substrate. The drive unit can be provided, for example, as a separate, detachably attachable unit on a preferably planar surface of the vacuum plate. It is preferred in the context of the invention that an interface is used to attach the drive unit to the functional unit or to the vacuum plate. In other words, the drive unit can be attached to the functional unit and/or to the vacuum plate of the functional unit by means of an interface. The interface is preferably a mechanical interface for connecting the drive unit to the functional unit or the vacuum plate.

It is preferred in the context of the invention that the vacuum plate is formed in several parts. According to the invention, it is preferred that the functional unit comprises at least one vacuum plate. In the context of the invention, this at least one vacuum plate can be referred to as the central or main vacuum plate of the functional unit or of the collection system. The central or main vacuum plate is preferably designed to support the drive unit and/or to guide the suction hose so that it opens out into the extraction opening of the extraction ring. In addition to the central vacuum plate, the functional unit can comprise further vacuum plates, which can be arranged, for example, on a circumference of the collection ring. For the purposes of the invention, the use of a plurality of vacuum plates is preferably referred to as the use of a “multi-part vacuum plate”. In one exemplary embodiment of the invention, the functional unit can comprise, for example, a central or main vacuum plate, and two additional secondary vacuum plates. The vacuum plates can be present, for example, distributed at regular intervals around a circumference of the collection ring. It may also be preferred in the context of the invention that the central or main vacuum plate is present arranged on a first side of the collection ring, while the secondary vacuum plates are arranged on the second or opposite side of the collection ring.

It is preferred in the context of the invention that the vacuum plates can be connected to each other via vacuum lines. It is preferred in the context of the invention that the further or secondary vacuum plates also have vacuum chambers, which can be formed as voids and/or cavities. Preferably, the vacuum chambers are provided on the undersides of the vacuum plates, wherein the underside of the vacuum plates rests on the substrate to be worked with the core drilling machine. This allows the vacuum plates to suction themselves to the substrate, thus enabling the collection system to be attached to the substrate. The vacuum for attaching the collection system is preferably generated by a vacuum pump that is part of the drive unit. The drive unit is preferably present arranged on the central or main vacuum plate, and there is preferably a fluidic connection between the at least one vacuum chamber of the central or main vacuum plate and the vacuum pump of the drive unit. Through the fluidic connection, the vacuum generated by the vacuum pump is transmitted to the vacuum chamber. In the context of the invention, this preferably means that the at least one vacuum chamber of the vacuum plate can be evacuated or exhausted via the fluidic connection to the vacuum pump. The at least one vacuum chamber of the central or main vacuum plate and/or the vacuum pump of the drive unit of the collection system can be connected to the other secondary vacuum plates or their vacuum chambers via vacuum lines. This allows the vacuum generated by the vacuum pump of the drive unit to be transferred to the vacuum chambers of the secondary vacuum plates. In the context of the invention, this preferably means that the vacuum chambers of the secondary vacuum plates can be evacuated or exhausted via the vacuum lines. The vacuum for this is generated by means of the vacuum pump of the drive unit and distributed—preferably uniformly—in the vacuum chambers of the vacuum plates of the functional unit by means of the vacuum lines. Due to the preferably uniform distribution of the vacuum to the various vacuum plates and the associated application of the vacuum at several locations, a particularly good, uniform attachment of the collection system to the substrate in which a core bore is to be made can be achieved.

In addition, the provision of a plurality of vacuum plates can advantageously increase the available space for attaching other items to the substrate. For example, the vacuum plates of the collection system can be used to attach tools, auxiliary equipment or other items used on a construction site to the substrate. For example, measuring or laser line equipment can be attached to the vacuum plate. The attachment of tools, auxiliary equipment or other items is particularly useful when the collection system is attached to a vertical wall and said items can then be located, for example, at the working or eye level of the user of the collection system. In addition, the use of a plurality of vacuum plates can increase the load capacity of the system, especially if the higher number of vacuum plates is accompanied by an increase in the vacuum area.

It is noted that in the context of the present invention, two different vacuum systems are distinguished from each other. Firstly, a first vacuum is provided which is generated by the vacuum pump of the drive unit of the collection system, wherein this first vacuum generated by the vacuum pump is used to attach the vacuum plates or the collection system or its components to a substrate. The first vacuum can be distributed under the vacuum plates of the collection system by means of vacuum lines, so that the collection system is attachable to the substrate in a particularly uniform and effective manner. Furthermore, in the context of the present invention, a second vacuum can be provided, which is generated by a suction device. With this second vacuum, the drilling slurry can be extracted from the collection ring, the second vacuum being transferred from the suction device to the collection system by means of a suction hose. In the context of the invention, this preferably means that the suction hose connects the suction device and the functional unit of the collection system, wherein the suction hose opens out into the vacuum plate or is guided through the vacuum plate in such a way that the drilling slurry can be extracted from the interior space of the collection ring through an extraction opening. The drilling slurry is preferably extracted by means of the second vacuum generated by the suction device, wherein the collection system can be connected to the suction device as an external auxiliary device. Preferably, the suction device does not constitute part of the collection system. Preferably, the above-mentioned core drilling machine is also not part of the collection system. Preferably, the collection system comprises the functional unit with a collection device and optionally at least one vacuum plate, as well as the drive unit with a vacuum pump for generating the first vacuum for fastening the system to a substrate and with a power supply device.

By providing two different vacuum systems, the collection system can be attached to a substrate independently of the operation of a suction device. This is not the case in many systems known from the prior art. Rather, conventional systems involve attaching a water or drilling slurry collection device to the substrate using the same vacuum that is also used to extract the drilling slurry. However, such an approach has several disadvantages. First, attachment of the collection device to the substrate can only be ensured when the suction device is switched on and running. This means, however, that the collection device must be constantly dismounted from the substrate or reattached to the substrate when the suction device is started up. This is cumbersome and laborious, and thus costly. Alternatively, the suction device can remain switched on even when it is not in use. However, this approach is associated with very high, unnecessary energy consumption, which is particularly disadvantageous if the suction device is also a battery-powered suction device. This is because the approach described considerably reduces the runtime of the power supply device of the suction device, or the intervals between two battery replacement operations are significantly shortened. In this respect, it is a significant advantage of the present invention that the second vacuum of the suction device is used for extracting the drilling slurry, while the first vacuum for attaching the collection system is generated by the vacuum pump of the collection system and thus does not load or shorten the runtime of the power supply device of the suction device. In the context of the invention, the vacuum chambers of the vacuum plates in which the first vacuum for attaching the collection system prevails are referred to as first vacuum chambers.

The collection device, from the interior space of which the drilling slurry is extracted, can also have at least one vacuum chamber, wherein the at least one vacuum chamber of the collection device is preferably referred to as a “second vacuum chamber” in the context of the invention. The second vacuum chamber can be formed, for example, by closing off the interior space of the collection device not only downwardly by the substrate, but also upwardly with respect to the environment. For this purpose, the collection device can, for example, have a cover device that closes this second vacuum chamber upwardly. The cover device preferably has an opening through which the drill bit of the core drilling machine can be guided. If the cover device comprises a compliant, elastic material, drill bits of different sizes can be used with the same diameter of the opening and still an acceptable sealing and suction effect of the suction device can be achieved. The compliant, elastic material can, for example, form a sealing disc through which the drill bit is guided when preparing for the core drilling. It is then not necessary to use a different collection device for each individual drill bit, but the compliant, elastic material of which the cover device of the collection device is at least partially made allows for a certain range of different drill bits to be used together with a particular extraction ring. This means that the user does not have to carry as many different collection devices if they want to perform several core drilling operations with different diameters. Of course, the second vacuum chamber can also be sealed downwards, i.e., toward the substrate, by a seal. This prevents air from flowing into or out of the second vacuum chamber from the surroundings of the collection system, so that the vacuum in the second vacuum chamber can be maintained with less effort.

In the context of the invention, the second vacuum chamber can preferably also be referred to as an extraction chamber. The terms “top” and “bottom” are not unclear terms for the person skilled in the art, because the terms “bottom” or “underside” or the spatial direction “downwards” are used in the context of the present invention for the side of the collection system facing the substrate, whereas the terms “top” or “upper side” or the spatial direction “upwards” are used in the context of the present invention for the side of the collection system facing away from the substrate. In this way, the terms are clearly defined not only when the collection system is used on a ground and a horizontal substrate, but also when the collection system is used on a vertical substrate, such as an external or internal wall.

In the context of the present invention, the separation of extraction and attachment is achieved in particular by providing at least two vacuum chambers in the system: a first vacuum chamber, which is formed by voids and/or cavities of the vacuum plate and which is evacuated by means of a vacuum pump of the drive unit, and a second vacuum chamber, which is formed by an interior space of the collection device and from which drilling slurry is extracted by means of an external suction device. For this purpose, the collection device can comprise a suction channel or a suction nozzle to which the external suction device can be connected. Preferably, the two vacuum chambers are fluidically separated from each other, so that no air can flow from one to the other vacuum chamber, or vice versa. Likewise, drilling slurry or water should not be able to pass from the second vacuum chamber into the first vacuum chamber, because this would contaminate the first vacuum chamber. This could compromise the attachment of the system. The fluidic separation of the two vacuum chambers can be further improved by seals and the like.

The power supply device of the drive unit is preferably provided for supplying electrical power to the components of the drive unit or the collection system. In the context of the invention, it is preferred that the collection system has a vacuum pump. However, it may also be preferred in the context of the invention that the collection system comprises more than one vacuum pump or also further pumps. The pumps represent electrical loads which draw the electrical power required for their operation from the power supply device of the drive unit. The power supply device can be a rechargeable battery having a plurality of energy storage cells. Preferably, the power supply device can also be referred to as an accumulator battery or “accumulator”. It is preferred in the context of the invention that the power supply device of the drive unit is charged while it remains in the collection system or its drive unit. For this purpose, the power supply device can be connected to a charger or to a public or construction site power supply. However, it may also be preferred in the context of the invention that the power supply device, for charging, be removed from the system and connected to an external charger.

In addition to the vacuum pump and the power supply device, the drive unit can comprise electronics for controlling the drive unit of the collection system. The electronics of the drive unit can preferably also obtain the energy required for their operation from the power supply device of the drive unit of the collection system. In this respect, the electronics of the drive unit preferably also constitute a consumer in the context of the present invention. For example, the electronics of the system can be used for closed-loop and/or open-loop control of the active components of the system, such as the vacuum pump. For example, the system can include a two-point controller that can be used to keep the vacuum in the first vacuum chamber of the vacuum plate within a predetermined pressure range. The open-loop and closed-loop control of the collection system can comprise a two-point controller designed to keep the first vacuum in the vacuum plate vacuum chamber between a desired lower limit and a desired upper limit for the vacuum. It is preferred in the context of the invention that the vacuum pump of the system is turned on or off when these thresholds of the desired pressure range are exceeded or undershot. Preferably, the vacuum pump is switched on to increase the vacuum, i.e. a difference to a pressure=0 bar, while the vacuum decreases continuously when the vacuum pump is switched off. In the context of the invention, a “decrease in the vacuum” represents an increase in pressure in absolute terms, in which the difference to a pressure=0 bar decreases, while an “increase in the vacuum” in the context of the invention represents a decrease in pressure in absolute terms, in which the difference to a pressure=0 bar increases.

In addition, the drive unit can comprise a switching device for switching the collection system or the drive unit on and off. Said switch can be a switch, for example a slide switch or a pressure switch. This enables independent operation of the collection system from the core drilling machine and/or the suction device. For example, the user can prepare the collection system prior to its use and prior to operating the core drilling machine, and can already attach the collection device to the substrate in which a core hole is to be drilled. The suction device for extracting the drilling slurry need only be switched on afterwards, for example merely while the core drilling is being carried out, so that the entire core drilling process can be carried out in a time- and energy-optimized manner.

In the context of the invention, it is preferred that the at least one vacuum plate has a seal. Preferably, the seal of the vacuum plate is provided on the underside of the latter and is designed to seal the at least one vacuum chamber of the vacuum plate. While normal or atmospheric pressure prevails in the environment of the collection system, the collection system is attached to the substrate by a vacuum, wherein the vacuum is generated by the vacuum pump of the collection system and prevails in the at least one vacuum chamber of the vacuum plate in the attached state of the system. To prevent air from the environment from flowing into or out of the vacuum chamber of the vacuum plate, a seal can be used to seal the vacuum chamber from the environment of the collection system. Advantageously, the seal helps the collection system to adhere particularly well even to rough surfaces.

In the context of the invention, it is preferred that the seal has a non-linear sealing profile. When the collection system is connected to the substrate in which a core hole is to be drilled, the vacuum plate is first placed on the substrate around the drilling location. At this time, an average distance between the vacuum plate and the substrate is, for example, 1. If the vacuum pump of the collection system is now switched on and the vacuum chamber of the vacuum plate is evacuated, the vacuum plate is sucked further and further towards the substrate and the average distance between the vacuum plate and the substrate decreases, i.e. becomes less than 1. The distance or path by which the distance between the vacuum plate and the substrate becomes smaller can preferably be referred to as a suction path I in the context of the invention. It is preferred in the context of the invention that the sealing effect or the suction force F changes as the suction path increases, wherein these changes in the sealing effect or the suction force F depend on the suction path I being referred to as the sealing profile. In the context of the invention, it is very particularly preferred if the sealing profile is non-linear. In the context of the invention, this preferably means that the sealing effect or the suction force F does not increase linearly with increasing suction path I, but that the sealing effect or the suction force F increases more quickly or more strongly with increasing suction path I, for example. In this context, the function of the sealing effect or the suction force F in dependence on the suction path I can represent, for example, a polynomial function of the nth degree, an exponential function or a function composed of different, for example linear, portions, for example a first portion with a first gradient m1 and a second portion m2, wherein the second gradient m2 is preferably greater than the first gradient m1. It is preferred in the context of the invention that a composite function of linear portions with different gradients is itself referred to as a “non-linear” function.

A non-linear sealing profile can be achieved, for example, by not using a conventional sealing ring, but by combining, for example, two sealing rings with different sealing and/or material properties, for example by placing them on top of each other. Alternatively, a sealing ring with a non-circular shape or cutting area in the profile section can be used. Such a sealing ring can have a triangular shape in profile, for example, wherein the shape of the sealing ring profile preferably tapers from top to bottom. Furthermore, two sealing rings with different heights can also be combined with each other, for example by placing the sealing rings next to each other. Preferably, a first sealing ring can have a first height h1 and a second sealing ring can have a second height h2, wherein the first height h1 is greater than the second height h2. When evacuating the vacuum chamber of the vacuum plate, the higher, first sealing ring with the first height h1 then initially contributes to sealing the vacuum chamber. The sealing effect or suction force F is determined by the first sealing ring in this first region, in which only the first sealing ring contributes to sealing. As the suction increases, the distance between the vacuum plate and the substrate decreases more and more, so that at a certain point the lower, second sealing ring with the second height h2 also contributes to the sealing. In this second region, in which both the first and the second sealing ring contribute to the sealing, the sealing effect or the suction force F is advantageously determined by both sealing rings. Preferably, the sealing effects of the sealing rings in this second region add up so that the sealing effect or the suction force F in the second region is greater than in the first region. This results in a function with a first, substantially linear region with a first gradient m1 and a second, substantially linear region with a second gradient m2, wherein the second gradient m2 is greater than the first gradient m1 due to the addition of the sealing effects of the sealing rings. Such a function or sealing profile extending in such a way is referred to as a “non-linear sealing profile” in the context of the invention. Preferably, such a non-linear sealing profile can be achieved by the sealing effect or suction force F changing non-linearly during the suction process, for example by the stiffness of the sealing material changing during the extraction process or by using sealing rings or materials with correspondingly tailored shapes.

It is preferred in the context of the invention that the system has an interface for connecting the drive unit and the functional unit, wherein the interface includes a line interface for transmitting the vacuum from the drive unit to the functional unit.

Preferably, the interface can comprise a line interface for transferring the vacuum from the vacuum pump of the drive unit to the vacuum chamber of the functional unit. Preferably, the line interface is designed as a detachable, quickly mountable, and yet leak-proof fluid line with which the vacuum generated by the vacuum pump can be transferred from the drive unit to the vacuum plate of the functional unit. It is preferred in the context of the invention that the air present in the vacuum chamber of the vacuum plate can be extracted through the line interface towards the vacuum pump.

In an embodiment also disclosed herein, the functional unit of the collection system can also be used without the drive unit, wherein, in which case, the functional unit side of the line interface can be connected to an external suction device, such as a vacuum cleaner or a wet-dry vacuum cleaner, wherein in this embodiment the suction device can be used to evacuate the vacuum chamber of the vacuum plate of the functional unit. It is preferred in the context of the invention that the line interface is designed to be self-locking on its functional unit side. As a result, the vacuum chamber of the vacuum plate of the functional unit is then also well sealed from the environment even when the drive unit is disassembled, i.e., when the functional unit is used without a drive unit.

In the context of the invention, it is preferred that the vacuum plate is part of the drive unit. It is preferred in this embodiment of the invention that the vacuum plate is not part of the functional unit, but part of the drive unit. In this embodiment of the invention, the functional unit comprises a collection device, which is designed in particular as a collection ring or as a water trap ring. In this embodiment, the vacuum plate is preferably referred to as a vacuum fixing base plate. In this embodiment of the invention, it is present firmly connected to the drive unit, wherein the drive unit can be present, for example, as a self-contained module arranged on the upper side of the preferably planar upper side of the vacuum fixing base plate. Also in this embodiment of the invention, the drive unit comprises a vacuum pump and a power supply device for supplying electrical power to the vacuum pump. In addition, the drive unit can comprise a switch for switching on and off, as well as electronics. In this embodiment, the fluid line between the drive unit and the vacuum fixing base plate can be a single fluid line, since it is not intended that the vacuum fixing base plate and the drive unit be detached from each other in this embodiment. In particular, the fluid line between the vacuum pump and the vacuum chamber of the vacuum fixing base plate can be designed to be particularly robust and technically easy to implement. The fluid line extracts the air out of the vacuum chamber of the vacuum fixing base plate towards the vacuum pump and evacuates the vacuum chamber in this way. The vacuum created in the vacuum chamber causes the vacuum fixing base plate to be sucked against the substrate, thereby fixing it to the substrate. In the embodiment in which the vacuum fixing base plate is part of the drive unit, the system formed of the collection device and the drive unit with vacuum fixing base plate can comprise a mechanical interface for connecting the vacuum fixing base plate to the collection device. This mechanical interface is preferably designed so that the drive unit with vacuum fixing base plate can be connected to collection devices of different sizes. Preferably, the connection between the collection device and the vacuum fixing base plate is made without tools. For example, the water trap ring can be clamped to the vacuum fixing base plate. In the embodiment of the invention in which the vacuum fixing base plate is part of the drive unit, the evacuation of the at least one vacuum chamber of the vacuum fixing base plate takes place by means of a first vacuum generated by the vacuum pump of the drive unit. The drilling slurry is extracted by means of a second vacuum generated by an external suction device, such as a vacuum cleaner or wet-dry vacuum cleaner. The collection device or the water trap ring can have a suction nozzle for attaching a suction hose, or can have other means for connecting a suction hose of a suction device.

Also, in this embodiment of the invention, the vacuum fixing base plate can be formed in several parts. In addition, the vacuum fixing base plate, which is part of the drive unit, can also have a seal with respect to the substrate, wherein the seal has a non-linear sealing profile.

Further advantages will become apparent from the following description of the figures. The figures, the description and the claims contain numerous features in combination. A person skilled in the art will expediently also consider the features individually and combine them to form sensible further combinations.

### BRIEF DESCRIPTION OF THE DRAWINGS

Identical and functionally identical components are denoted by the same reference signs in the figures.

In the drawings:

FIG. 1 shows a view of a preferred embodiment of the collection system with functional unit and drive unit in a connected state

FIG. 2 shows a view of a preferred embodiment of the collection system with functional unit and drive unit in a separated state

FIG. 3 shows a schematic top view of a preferred embodiment of the collection system

FIG. 4 shows a schematic side view of a preferred embodiment of the collection system

FIG. 5 shows a schematic top view of a preferred embodiment of the collection system with several vacuum plates

FIG. 6 shows a schematic representation of different non-linear sealing profiles

FIG. 7 shows a top view of a preferred embodiment of the collection system, in which the vacuum plate is part of the drive unit

### DETAILED DESCRIPTION

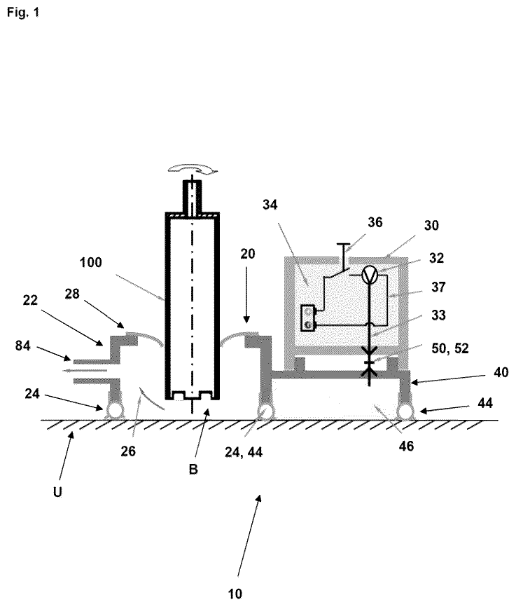

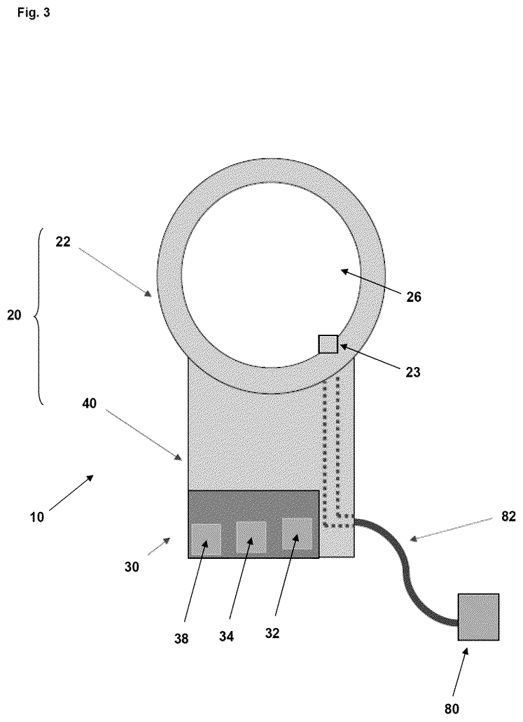

FIG. 1 shows a preferred embodiment of the collection system 10 with functional unit 20 and drive unit 30 in a connected state. In the exemplary embodiment of the invention shown in FIG. 1, the functional unit 20 comprises a water trap ring 20 as a collection device 20, as well as a vacuum plate 40 with which the collection system can be attached to a substrate U. The substrate U can be worked by a core drilling machine 100 in the sense that a core hole is drilled into the substrate U. For this purpose, the core drilling machine 100 can include a drill bit, shown in FIG. 1 as representative of the core drilling machine 100. When the core drilling operation is performed, drilling slurry B is produced as a mixture of cooling or flushing water, dust, and drilled material. This drilling slurry B collects in an interior space 26 of the collection device 22. The interior space 26 of the collection device 22 can be connected to an external suction device 80 via a suction nozzle 84 and a suction hose 82 (see, e. g, FIG. 3), so that the drilling slurry B can be extracted from the interior space 26 of the collection device 22 by a vacuum. This means that the interior space 26 of the collection device 22 can be subjected to a vacuum generated by the suction device 80. As a result, the interior space 26 of the collection device 22 becomes a vacuum chamber, which is referred to as a second vacuum chamber 26 in the context of the invention. A possible path of the drilling slurry B is indicated by arrows in FIG. 1. The interior space 26 of the collection device 22 can be closed with a cover device 28 to form a vacuum chamber 26. The interior space 26 of the collection device 22 can thus be closed downwardly, i.e. in the direction of the substrate U, by the substrate U itself, wherein seals 24 help to seal the vacuum chamber 26 particularly effectively. In the spatial direction “upwards”, i.e. on the side of the collection device 22 facing away from the substrate U, the cover device 28 is preferably provided. The cover device 28 can comprise, for example, a compliant, elastic material which can form, for example, a sealing disc. The cover device 28 can have an opening through which the drill bit of the core drilling machine 100 can be guided in order to perform the core drilling, surrounded by the collection device 22.

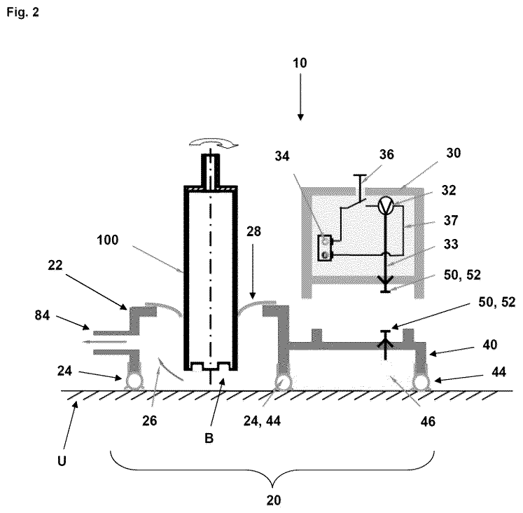

In the embodiment of the invention shown in FIG. 1, the vacuum plate 40 is part of the functional device 20. The vacuum plate 40 also has a vacuum chamber 46, wherein the vacuum chamber 46 of the vacuum plate 40 is referred to as the first vacuum chamber 46 in the context of the invention. The first vacuum chamber 46 can be subjected to a vacuum, which can be generated by a vacuum pump 32 of a drive unit 30 of the collection system 10. In the exemplary embodiment of the invention shown in FIG. 1, the functional unit 20 and the drive unit 30 of the system 10 represent separate units 20, 30 from each other, wherein the units 20, 30 are connected to each other in FIG. 1 and are separate from each other in FIG. 2. This separation allows, for example, the drive unit 30 to be used in combination with different functional units 20, wherein the functional units 20 differ, for example, in the diameter of the collection ring 22. In this way, the collection system 10 can be adapted in a particularly simple and user-friendly manner to core drilling machines 100 and drill bits with different diameters.

The vacuum plate 40 can be sealed with respect to the substrate U with seals 44, while the collection device 22 can be sealed with respect to the substrate with seals 24. Seals can also be provided in the transition region between the vacuum plate 40 and the collection device 22, and in the context of the present invention are referred to as “seal 24, 44”. The seal 24, 44 ensures that there is no exchange of air or drilling slurry between the first vacuum chamber 46 of the vacuum plate 40 and the second vacuum chamber 24 of the collection device 22. In other words, the seal 24, 44 seals the vacuum chambers 26, 46 from each other. The seal 24 seals the second vacuum chamber 26 of the collection device 22 from the environment or atmospheric pressure in the environment of the collection system 10, while the seal 44 seals the first vacuum chamber 46 of the vacuum plate 40 from the environment or atmospheric pressure in the environment of the collection system 10. The first vacuum in the first vacuum chamber 46 is used to attach the system 10 to the substrate U, while the second vacuum in the second vacuum chamber 26 is used to evacuate the drilling slurry B from the interior space 26 of the collection device 22. The first vacuum can be generated by a vacuum pump 32 of the drive unit 30, while the second vacuum can be generated by an external suction device 80. The seals 24, 44 can have a non-linear sealing profile, such that an improved sealing effect of the seals 24, 44 can be enabled.

In addition to the vacuum pump 32, the drive unit 30 of the collection system 10 includes a power supply device 34 for supplying electrical power to the vacuum pump 32. Electrical lines 37 can be routed within the drive unit 30 and electrically conductively connect, for example, the power supply device 34, the vacuum pump 32, a switch 36, and/or electronics 38 of the drive unit 30 to one another. The switch 36 can be used to switch the system 10 or the drive unit 30 and its components, for example the vacuum pump 32, on or off. The electronics 38 of the drive unit 30 can be used to for closed-loop and/or open-loop control of the drive unit 30 and/or the vacuum pump 32. For example, the operation of the vacuum pump 32 can be controlled to ensure that a vacuum in the first vacuum chamber 46 of the vacuum plate 40 always remains within a desired pressure range. This can ensure that the vacuum plate 40 and the water trap ring 22 connected to the vacuum plate 40 are always securely attached to the substrate U. The power supply device 34 is preferably a rechargeable battery having multiple energy storage cells. The power supply device 34 can be in the form of an accumulator battery (“accumulator”) that can be recharged with electrical power either in the drive unit 30 or in an external charger (not shown).

A fluid line 33 can exist between the vacuum pump 32 and the first vacuum chamber 46 of the vacuum plate 40 and can include a line interface 52. The line interface 52 can be part of a mechanical interface 50 for connecting the functional unit 20 to the drive unit 30. The interface 50 allows for easy separation of the drive unit 30 from the functional unit 20 without tools, while the line interface 52 allows for easy separation of the fluid line 33. The line interface 52 can be self-locking on the vacuum plate 40 side and/or on the drive unit 30 side so that when the units 20, 30 are separated, the fluid line 33 is sealed.

FIG. 2 shows a preferred embodiment of the collection system 10 with functional unit 20 and drive unit 30 in a separated state.

FIG. 3 shows a schematic top view of a preferred embodiment of the collection system 10. The functional unit 20 with the collection device 22 and the drive unit 30 are shown. The collection device 22 can be annular so that an interior space 26 is formed. When core drilling is performed, the drilling slurry B collects in this interior space 26 and can be extracted via the extraction opening 23 of the collection device 22 by means of a suction device 80. The collection device 22 can be connected for this purpose to the suction device 80 via a suction hose 82. The suction device 80 is designed to generate a vacuum for extracting the drilling slurry B, wherein the interior space 26 of the collection device 22 is acted upon by the vacuum and thus serves as an extraction or vacuum chamber 26. The interior space 26 of the collection device 22 can be closed at the top by a cover device 28 (see FIGS. 1 and 2). Downwardly, the interior space 26 of the collection device 22 is closed by the substrate U into which the core bore is to be made. The suction hose 82 can be extended through the functional unit 20 until it opens out into the interior space 26 of the collection device 22 in the region of the extraction opening 23. This extension of the suction hose 82 inside the functional unit 20 is shown with dashed lines in FIGS. 3 to 5.

The drive unit 30 of the collection system 10 can include electronics 38 for closed-loop and/or open-loop control of the components of the drive unit 30. For example, the vacuum pump 32 and/or the power supply device 34 or respective operation thereof can be subject to open-loop and/or closed-loop control by the electronics 38 of the drive unit 30. In the embodiment of the collection system 10 shown in FIG. 3, the vacuum plate 40 is part of the functional unit 20. In the exemplary embodiment of the invention shown in FIG. 3, the vacuum plate 40 is formed in one piece, wherein the one vacuum plate 40 of the exemplary embodiment of the invention shown in FIG. 3 is preferably referred to as the central or main vacuum plate 40.

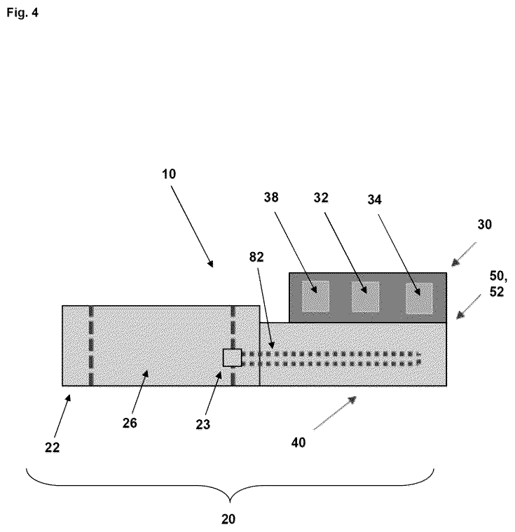

FIG. 4 shows a schematic top view of a preferred embodiment of the collection system 10, in particular the collection system 10 shown in FIG. 3. In particular, a possible arrangement of the drive unit 30 of the system 10 on the functional unit 20 is shown. For example, the drive unit 30 can be arranged on an upper side of the functional unit 20 or on an upper side of the vacuum plate 40 of the functional unit 20. In FIG. 4, the interior space 26 of the collection device 22, as well as the extension of the suction hose 82 inside the functional unit 20 are indicated with dashed lines, since they are not visible from the outside in the side view. The drive unit 30 and the functional unit 20 can be connected to each other by means of an interface 50, wherein the interface 50 is preferably a mechanical interface. The interface 50 can comprise a line interface 52, which is designed to connect the fluid line 33 on the side of the drive unit 30 and on the side of the vacuum plate 40 of the functional unit 20 to one another or—in the separated state—to tightly seal the fluid line 33 on the side of the drive unit 30 and on the side of the functional unit 20.

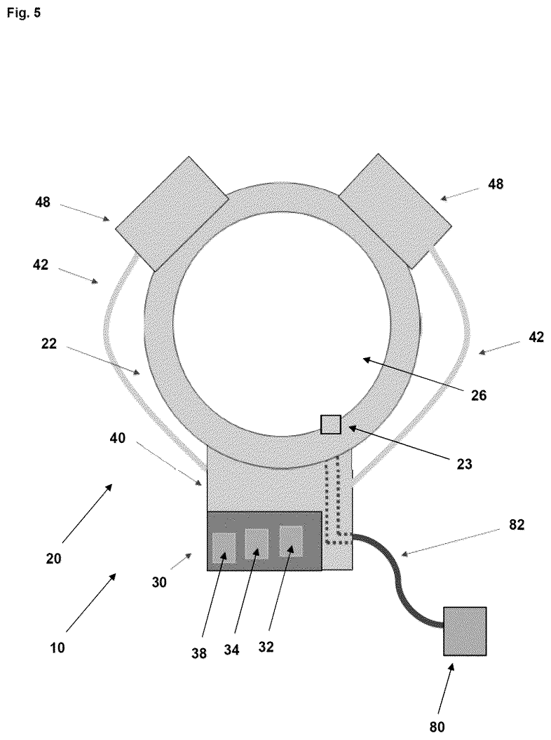

FIG. 5 shows a schematic top view of a preferred embodiment of the collection system 10 with a plurality of vacuum plates 40, 48. In the exemplary embodiment of the invention illustrated in FIG. 5, the vacuum plates 40, 48 are part of the functional unit 20. The functional unit 20 comprises a main vacuum plate 40, on which, for example, the drive unit 30 can be arranged. In addition, the exemplary embodiment of the collection system 10 illustrated in FIG. 5 comprises further vacuum plates 48, which can be arranged, for example, on the opposite side of the functional unit 20 of the collection system 10. As a result, the vacuum plate 40, 48 of the exemplary embodiment of the collection system 10 illustrated in FIG. 5 has a multi-part design, i.e. the collection system 10 illustrated in FIG. 5 has a plurality of vacuum plates 40, 48, wherein the collection system 10 illustrated in FIG. 5 has in particular a central or main vacuum plate 40 and two further vacuum plates 48. The further vacuum plates 48 also have vacuum chambers 46, which can be evacuated by means of the vacuum pump 32 of the drive unit 30. The vacuum plates 40, 48 can be connected to each other and/or to the vacuum pump 32 of the drive unit 30 via vacuum lines 42. The vacuum chambers 46 of the vacuum plates 40, 48 can be evacuated or subjected to a vacuum via the vacuum lines 42. In this way, the collection system 10 can be attached to the substrate U.

To extract the drilling slurry B from the interior space 26 of the collection device 22, the collection system 10 can be connected to an external suction device 80, wherein a suction hose 82 can be used for this connection. The functional unit 20 or the collection device 22 can have a suction nozzle 84 (see FIGS. 1 and 2) onto which the suction hose 82 can be fitted. The vacuum for extracting the drilling slurry B can be brought into the region of the extraction opening 23 of the collection device 22 via the suction hose 82 and a possible extension of the suction hose 82 through the functional unit 20, so that the drilling slurry B can be extracted from the interior space 26 of the collection device 22 through the extraction opening 23.

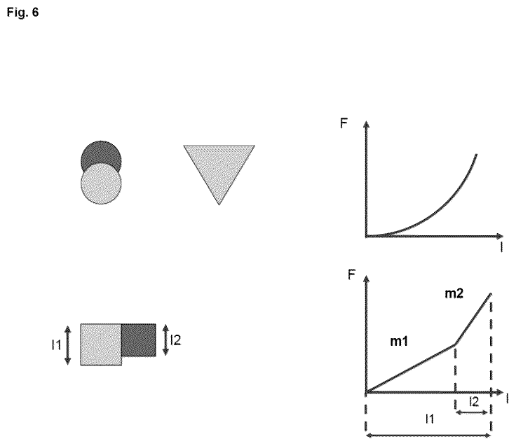

FIG. 6 shows a schematic representation of various non-linear sealing profiles. On the left half of FIG. 6, sections through schematic exemplary sealing arrangements are shown. The right half of FIG. 6 shows the associated sealing profiles, wherein the sealing effect or suction force F is plotted against the suction path I in each case. In the context on the invention, the suction path I is preferably the path by which the distance between the vacuum plate and the substrate decreases when the vacuum pump 32 of the collection system 10 is switched on and the vacuum chamber 46 of the vacuum plate 40 is evacuated. This is because by applying a vacuum to the vacuum chamber 46 of the vacuum plate 40, the vacuum plate 40 is sucked towards the substrate U and thereby attached to the substrate U. In the upper right quarter of FIG. 6, a sealing profile F(I) is shown, which has, for example, an exponential or quadratic course. The sealing effect and the suction force F increase slowly at first and then more and more rapidly as the suction path increases. Such a course of the sealing profile can be achieved, for example, with a tapering sealing arrangement (schematically: triangular sectional profile of the sealing arrangement) or by two sealing rings placed one above the other, wherein the sealing rings can, for example, comprise different materials or can have a different material composition.

In the lower right quarter of FIG. 6, a sealing profile F(I) is shown which is composed of two substantially linear portions with different gradients m. The gradient m2 for larger suction paths I is greater or higher than the gradient m1 for smaller or shorter suction paths I. The sealing effect and the suction force F first increase slowly with a gradient m1 and then, from a kink point, with a gradient m2, wherein m2>m1. Such a course of the sealing profile can be achieved, for example, with a sealing arrangement consisting of two sealing rings placed next to each other, wherein the sealing rings can have different heights, h1 and h2. Whereas, with small suction paths I, initially only the first sealing ring with a height h1 contributes to the sealing effect, from the kink point both sealing rings contribute to the sealing effect, so that the sealing effects of the individual sealing rings add up and the sealing effect therefore increases more rapidly from the kink point. In the example shown at the bottom of FIG. 6, the height h1 of the first sealing ring is greater than the height h2 of the second sealing ring. It has been shown that, by using a sealing arrangement with a non-linear sealing profile, particularly effectively sealing vacuum chambers 46 can be obtained, so that a particularly stable, robust and secure attachment of the collection system 10 to the substrate U to be worked can be made possible.

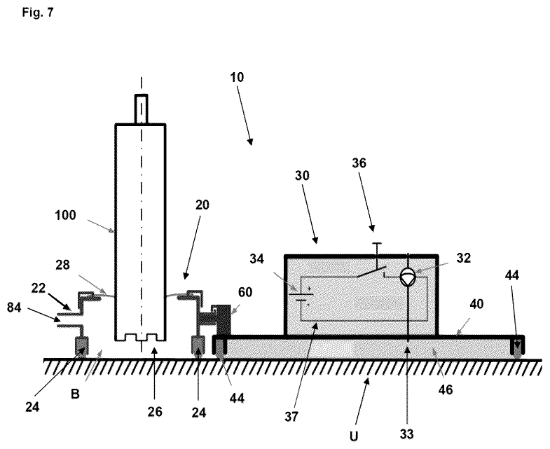

FIG. 7 shows a schematic side view of a preferred embodiment of the collection system 10, in which the vacuum plate 40 is part of the drive unit 30. In this embodiment of the invention, the collection device 22 of the system 10 can be kept particularly simple. The water trap ring 22 can be covered by a cover device 28 and sealed with respect to the substrate U and/or the vacuum chamber 46 of the vacuum plate 40 by a water trap seal 24. The water trap ring 22 can be connected to an external suction device 80 via a suction nozzle 84 and a suction hose 82, so that the drilling slurry B produced during the execution of a core drilling operation can be extracted from the interior space 26 of the water trap ring 22. The water trap ring 22 can form an attachment to the drive unit 30, in particular the vacuum plate 40 of the drive unit 30, by means of an interface 60, in order to form a collection system 10. The vacuum plate 40 of the drive unit 30 can preferably be referred to as the vacuum fixing base plate 40 in this exemplary embodiment of the invention. The vacuum fixing base plate 40 can be sealed with respect to the substrate U by seals 44, and its vacuum chamber 46 can be subjected to a vacuum from the vacuum pump 32 of the drive unit 30. As a result, the vacuum fixing base plate 40 adheres to the substrate U and the collection system 10 can be fixed to the substrate U in this way. The drive unit 30 of the system 10 comprises, in addition to the vacuum pump 32, a power supply device 34 and optionally an on/off switch 36 and/or electronics 38 for open-loop and/or closed-loop control of the collection system 10 or its active components, such as vacuum pump 32 or power supply device 34. The electrical components of the drive unit 30, such as power supply device 34, switch 36, vacuum pump 32 or electronics 38, can be electrically conductively connected to one another via electrical lines 37. The vacuum pump 32 and the vacuum chamber 46 of the vacuum plate 40 can be fluidically connected to each other via a fluid line 33.

### LIST OF REFERENCE SIGNS

10 collection system
20 functional unit
22 collection device
23 extraction opening
24 seal of the collection device
26 second vacuum chamber of the collection device
28 covering device
30 drive unit
32 vacuum pump
33 fluid line
34 power supply device
36 switching device
37 electrical line
38 electronics
40 vacuum plate
42 vacuum lines
44 seal of the vacuum plate
46 first vacuum chamber of the vacuum plate
48 further vacuum plates
50 interface between functional unit and drive unit
52 line interface
60 interface between collection device and vacuum plate
80 suction device
82 suction hose
84 suction nozzle on the collection device
100 core drilling machine, especially drill bit
B drilling slurry
U substrate

What is claimed is:

1.-9. (canceled)

10. A system for collecting drilling slurry produced during operation of a core drilling machine, the system comprising:
a drive unit having a vacuum pump and a power supply for supplying electrical power to the drive unit; and
a functional unit including a collector attachable to a substrate by a vacuum generatable by the vacuum pump.

11. The system as recited in claim 10 wherein the drive unit is detachably attachable to the functional unit.

12. The system as recited in claim 10 wherein the functional unit includes at least one vacuum plate for transmitting the vacuum to the substrate.

13. The system as recited in claim 12 further comprising an interface for connecting the drive unit and the functional unit, the interface including a line interface for transmitting the vacuum from the drive unit to the functional unit.

14. The system as recited in claim 10 wherein the drive unit includes at least one vacuum plate for transmitting the vacuum to the substrate.

15. The system as recited in claim 12 wherein the at least one vacuum plate includes a plurality of vacuum plates

16. The system as recited in claim 15 wherein the plurality of vacuum plates are connectable to each other or to the vacuum pump via vacuum lines.

17. The system as recited in claim 12 wherein the at least one vacuum plate has a seal.

18. The system as recited in claim 14 wherein the at least one vacuum plate has a seal.

19. The system as recited in claim 18 wherein the seal has a non-linear sealing profile.

20. The system as recited in claim 17 wherein the seal has a non-linear sealing profile.
